(19) United States
(12) Patent Application Publication
(10) Pub. No.: US 2008/0149223 A1
(43) Pub. Date: Jun. 26, 2008

(54) ROUTER

(76) Inventors: Adolf Zaiser, Koengen (DE); Heiko Roehm, Stuttgart (DE); Jens Blum, Filderstadt (DE)

Correspondence Address: Striker, Striker & Stenby, 103 East Neck Road, Huntington, NY, 11743, US

(21) Appl. No.: 11/873,990

(22) Filed: Oct. 17, 2007

(30) Foreign Application Priority Data
Dec. 22, 2006 (DE) 10 2006 061 242.6

(51) Int. Cl. B27C 5/00

(52) U.S. Cl. 144/154.5

(57) ABSTRACT

A router has a motor housing that includes an upper piece, and the upper piece of the motor housing includes at least two shells capable of being joined together, the parting plane of which extends essentially in the direction of a vertical axis of the router.

### CROSS-REFERENCE TO A RELATED APPLICATION

The invention described and claimed hereinbelow is also described in German Patent Application DE 102006061242.6 filed on Dec. 22, 2006. This German Patent Application, whose subject matter is incorporated here by reference, provides the basis for a claim of priority of invention under 35 U.S.C. 119(a)-(d).

### BACKGROUND OF THE INVENTION

The present invention relates to routers.

A generic router is made known in DE 41 39 759 A1. The router includes a motor housing with two handles, and a drive motor located in the is motor housing. A tool fitting connected with the drive motor extends out of the underside of the motor housing. The drive motor is connected with a connecting line, which extends out of the motor housing. The router has a pot-shaped design, with the motor housing including a pot-shaped upper piece and a lower piece.

### SUMMARY OF THE INVENTION

Accordingly, it is an object of the present invention to provide a router which is a further improvement of the existing routers.

More particularly, it is an object of the present invention to provide a router with a motor housing that includes an upper piece, which is a further improvement of the existing routers of this type.

In accordance with the present invention it is provided that the upper piece of the motor housing includes at least two shells, which are capable of being joined together, the parting plane of which extends essentially in the direction of a vertical axis of the router.

When the router is designed in accordance with the present invention as specified herein above, it has a robust motor housing, which allows the router to be assembled in a cost-favorable manner. In this context, the expression “essentially in the direction of a vertical axis” is understood to mean that slight deviations by the parting plane from the vertical axis are included in the safety margin, particularly within a range of ±10°.

In a further embodiment of the present invention of the at least two shells of the motor housing which are joined together, it is provided that the parting plane extends through at least one handle. Thereby good access to the interior of the handle during assembly is provided.

It is also provided that at least one handle is designed as a single piece with the motor housing, i.e., the handle preferably extends through the parting plane, and/or the half shells of the handle are designed as single pieces with the half shells of the motor housing. A stiff handle connection is attained as a result, which ensures that the handles remain adequately stable even in exceptional situations, e.g., when the router is dropped.

It is also provided that the router includes a connecting line, which is guided out of the motor housing on a handle and, in particular, on a top side of the handle. A design of this type makes it possible to operate the router without interruption, since, during operation, the connecting line is guided away from the tool fitting and, therefore, away from a tool that poses a danger to the connecting line.

In a further embodiment, it is provided that the handle, on which the connecting line is guided out of the motor housing, includes a switch for starting the drive motor, thereby simplifying the guidance of the line in the motor housing. It is only necessary to guide the connecting line from the drive motor to the switch, which is located in the handle, and, just a short distance later, to then guide it out of the handle. As such, the typical duplicate guidance of lines in the motor housing may be prevented.

It is also provided that the handle includes a removable cover, thereby simplifying the repair and maintenance of the hand-held device. This makes it possible to easily replace the cable and switch, since both of them are located in the interior of the handle, which is accessible via the cover.

It is also provided that, when the cover is installed on the handle, it extends over the shells of the handle and draws them together, thereby also increasing the stability of the motor housing. This also simplifies the assembly of the router, since installing the cover simultaneously serves to connect the shells.

In a further embodiment, it is provided that the shells of the upper piece form a tower for receiving a first guide column, on which a clamping ring is pressable, by way of which the stability of the motor housing is also increased, in a simple manner. In addition, the clamping ring is very easy to install.

It is also provided that, in the region of a top end of a second guide column, a shell includes an installation cover, which makes it possible to easily and quickly replace a wear-relevant part, even with the motor housing closed.

It is also provided that the installation cover motion is capable of being clipped into the shell. As a result, there is no need to use a tool to open and close the motor housing.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 shows a perspective view of a router with a motor housing that includes an inventive router with two handles, and a drive motor located in the motor housing, and

FIG. 2 shows the router in accordance with the present invention in a partial sectional view.

### DESCRIPTION OF THE PREFERRED EMBODIMENTS

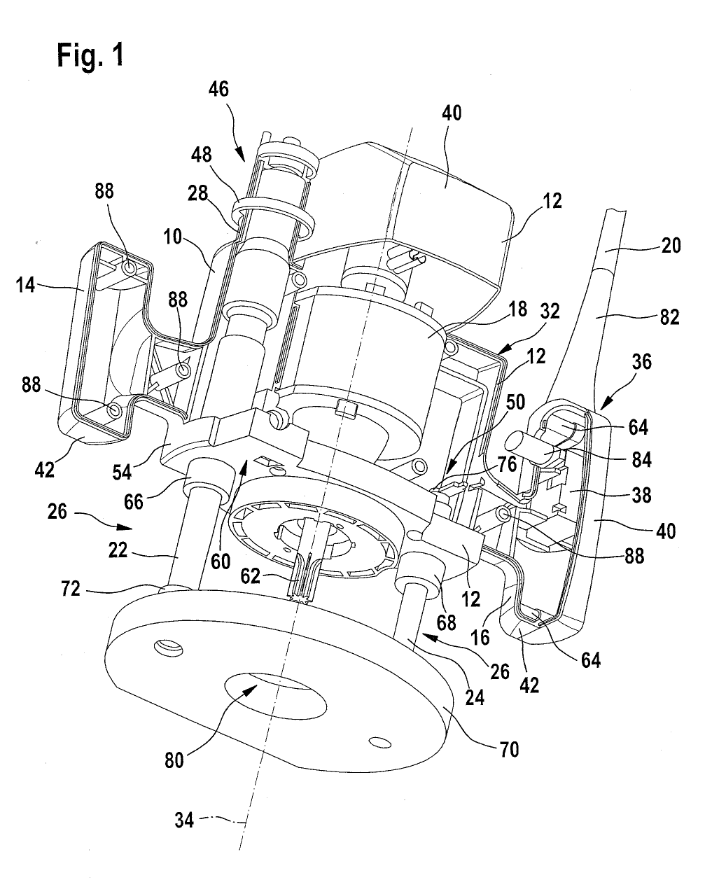

FIG. 1 shows a perspective view of an inventive router in an opened state. The router includes a motor housing 12, which is composed of a lower piece 54, an upper piece 10, and a cover 40. Further embodiments of motor housing 12, e.g., without a cover, are also feasible.

Motor housing 12 includes at least one handle 14, 16, which is fixedly connected with motor housing 12. In the present exemplary embodiment, the router includes two handles 14 and 16, which are diametrically opposed to each other. Further alternatives are also feasible, however.

A drive motor 18, which starts a motor spindle 56 rotating, is located in motor housing 12. Motor spindle 56 is non-rotatably connected with a tool fitting 58, which extends out of an underside 60 of motor housing 12, and in which a milling tool 62 may be secured—preferably clamped—in order to machine a work piece.

First guide tubes 66, 68, which extend essentially parallel to a vertical axis 34 of the router and a vertical axis 34 of milling tool 62, are integrally moulded with lower piece 54 of the motor housing. First guide tubes 66, 68 line up directly with second guide tubes 72, 74, which are also oriented essentially parallel to a vertical axis 34 of the router and a vertical axis 34 of milling tool 62, and which are integrally moulded with base plate 70.

Two guide columns 22, 24 of a guide unit 26 are guided and supported in first and second guide tubes 66, 68 and 72, 74. A first guide column 22, as the main column, is hollow in design, and a second guide column 24 is solid in design. Motor housing 12 is accommodated on guide columns 22, 24 such that it is displaceable essentially parallel to axis 34 of milling tool 62, and it is detachably fixable relative to at least one of the guide columns 22 using a not-shown clamping device.

A snap ring 76 is located in an annular groove on an upper end of solid guide column 24 facing upper piece 10. It prevents motor housing 12 from accidentally sliding off of guide columns 22, 24. Solid guide column 24 prevents motor housing 12 from rotating, and serves to limit the upper extent of the reciprocating motion.

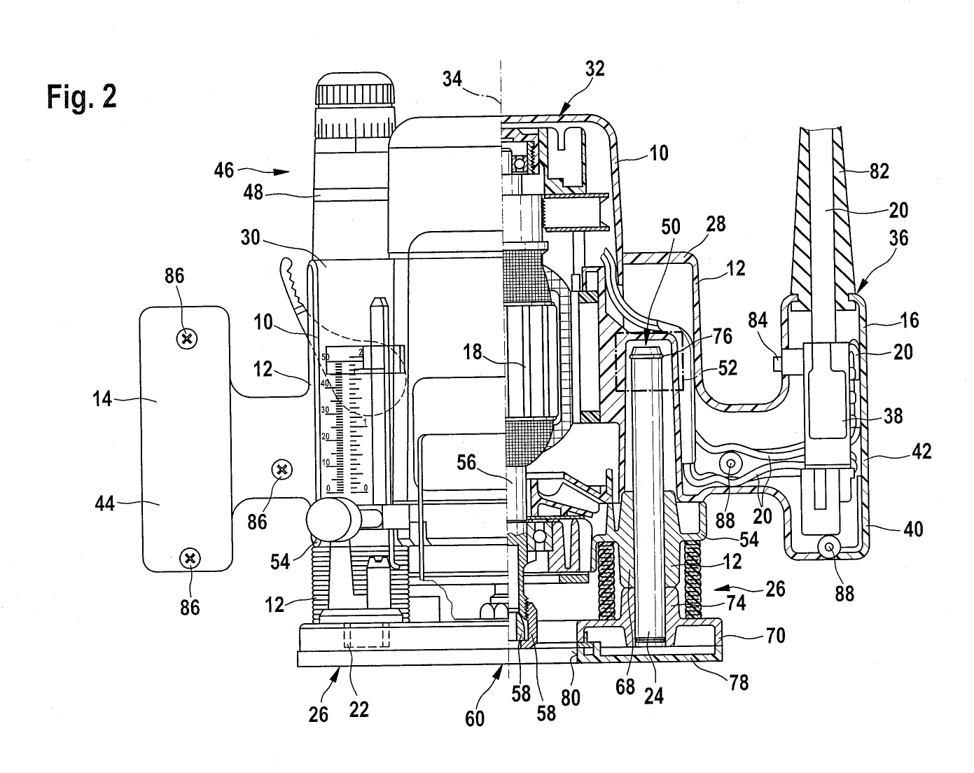

As shown in FIG. 2, base plate 70 includes a lower piece 78—which is preferably composed of plastic—for protecting the work piece to be machined. Base plate 70 and lower piece 78 have a central opening 80, into which motor spindle 56 of drive motor 18 located in motor housing 12 extends at least partially.

According to the present invention, and as shown in FIGS. 1 and 2, upper piece 10 of motor housing 12 includes two shells 28 and 30 capable of being joined together, the parting plane 32 of which extends essentially in the direction of a vertical axis 34 of the router. Half shells 28, 30 are interconnected via screws 86. One half shell 28 includes bolt posts 88 with inner threads, bolt posts 88 being integrally moulded with half shell 28, into which screws 86 inserted in the other half shell 30 may be screwed during assembly. Other types of fastening methods known to one skilled in the art may also be used to connect half shells 28, 30 with each other.

Advantageously, parting plane 32 of half shells 28, 30 extends through both handles 14, 16. Any other course of parting plane 32 is also feasible, however. In the present exemplary embodiment, the two handles 14,16 of motor housing 12 are preferably integrally moulded with upper piece 10 and both half shells 28, 30 of upper piece 10. Via the course of parting plane 32, handles 14, 16 are also divided into two handle half shells 42, 44, which are integrally moulded on an upper piece half shell 28, 30.

Drive motor 18 is connected with a connecting line 20, which extends through a protective grommet 82 and out of motor housing 12, and which may represent the connection to a not-shown voltage source. In the present exemplary embodiment, connecting line 20 is guided on one of the two handles 14,16, preferably on an upper side 36 of one of the two handles 14, 16. Advantageously, handle 16—on which connecting line 20 is guided out of motor housing 12—is hollow in design and includes a switch 38 for connecting drive motor 18 to the voltage source, i.e., an on/off switch for drive motor 18.

Switch 38 for starting drive motor 18 is located inside handle 16 and includes a pushbutton 84, which is operatively connected with switch 38. When pushbutton 84 is depressed, switch 38 and connecting line 20 connected to the voltage source establish the electrical connection between drive motor 18 and the voltage source in the typical manner. Handle 16 includes a removable cover 40, which may be removed for maintenance or repair of switch 38 or associated lines 20.

Cover 40 is designed such that, when handle 16 is installed, it extends over handle half shells 42, 44 and simultaneously draws them together. In the present exemplary embodiment, cover 40 is connected via screw connections 64 with handle 16. Other fastening methods that appear reasonable to one skilled in the art, e.g., clip connections, may also be used.

Half shells 28, 30 of upper piece 10 form a tower 46 for receiving first guide column 22, and onto which a clamping ring 48 is pressable.

To easily replace snap ring 76, which is located on upper end 50—which faces upper piece 10—of solid guide column 24, one of the half shells 28, 30 of upper piece 10 includes an installation cover 52 to be opened. In the present exemplary embodiment, installation cover 52 is preferably capable of being clipped into half shell 28, 30.

Other fastening methods that appear reasonable to one skilled in the art are also feasible, however.

It will be understood that each of the elements described above, or two or more together, may also find a useful application in other types of constructions differing from the type described above.

While the invention has been illustrated and described as embodied in a router, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A router, comprising a motor housing having an upper piece, said upper piece of said motor housing including at least two shells which are joined together over a parting plane which extends substantially in a direction of a vertical axis of the router.

2. A router as defined in claim 1; and further comprising at least one handle, said parting plane of said at least two shells of said upper piece of said motor housing extending through said at least one handle.

3. A router as defined in claim 2, wherein said at least one handle is configured as one piece with said motor housing.

4. A router as defined in claim 1; and further comprising at least one handle; and a connecting line which is guided out of said motor housing on said handle.

5. A router as defined in claim 4, wherein said connecting line extends out of said motor housing on a top side of said handle.

6. A router as defined in claim 1; and further comprising a drive motor; and a handle that includes a switch for starting said drive motor.

7. A router as defined in claim 1; and further comprising a handle which includes a removable cover.

8. A router as defined in claim 7; and further comprising a handle, said cover being installed on said handle, extending over shells of said handle and drawing them together.

9. A router as defined in claim 1, wherein said shells of said upper piece of said motor housing form a tower; and further comprising a first guide column which is received by said tower; and a clamping ring which is pressed onto said first guide column.

10. A router as defined in claim 11; and further comprising a second guide column; and an installation cover provided in one of said shells in a region of a top end of said second guide column.

11. A router as defined 1 0, wherein said installation cover is clipped into said one shell.
